(19) United States
(12) Patent Application Publication
(10) Pub. No.: US 2019/0288564 A1
(43) Pub. Date: Sep. 19, 2019

(54) VISUALIZATION OF INTENSITY AND DIRECTIONALITY OF ULTRASONIC WAVEFORMS

(71) Applicant: uBeam Inc., Santa Monica, CA (US)

(72) Inventors: Ross Chun, Los Angeles, CA (US); Ken Bates, Portland, OR (US)

(21) Appl. No.: 15/919,544

(22) Filed: Mar. 13, 2018

(51) Int. Cl. H02J 50/15; H02J 50/90; H02J 50/40

(52) U.S. Cl. CPC H02J 50/15; H02J 50/40; H02J 50/90

(57) ABSTRACT

Systems and methods are provided for a visual indication of acoustic energy fields, such as with ultrasonic energy waves. At least one of a plurality of transducers may receive ultrasonic energy waves and convert the received ultrasonic energy waves into a first type of electrical power. A power converter may convert the first type of electrical power into a second type of electrical power. One or more light emitting devices may be powered with the second type of electrical power from the power converter to output light corresponding to the received ultrasonic energy waves by the at least one of the plurality of transducers to provide a visual indication of ultrasonic energy, such as a visual indication of the focus and directionality of the ultrasonic energy waves.

### BACKGROUND

Ultrasonic waves may be used to transfer power wirelessly between ultrasonic transducers. Multiple ultrasonic transducers may be used to transmit power to multiple ultrasonic transducers. Such ultrasonic waves are invisible to the human eye. Although some present ultrasound systems can display a detected acoustic power level, such systems do not provide a way to visualize ultrasonic waves as they propagate through various mediums, such as air, water, or solids. Other present ultrasound systems can visualize acoustic energy by using Schlieren imaging to visualize acoustic fields, where an image of the acoustic energy is created as it travels through fluids which typically have varying densities. Still other present ultrasound systems utilize an acoustic camera to capture an image of acoustic energy.

### BRIEF SUMMARY

Implementations of the disclosed subject matter provide a visual indication of acoustic energy fields, such as with ultrasonic energy waves. Implementations disclosed herein provide an array of light emitting devices to provide a visual indication of acoustic energy fields that may be transmitted via an array of ultrasonic transducers. Visualization of acoustic energy may be desirable for applications such as energy transfer (e.g., for power applications), diagnostic testing, and/or haptics control. Implementations of the disclosed subject matter provide for visualization of ultrasonic energy waves so that their focus, directionality, dispersion pattern, strength, and/or coverage area may be determined.

According to an implementation of the disclosed subject matter, a system is provided that includes at least one of a plurality of transducers to receive ultrasonic energy waves and convert the received ultrasonic waves into a first type of electrical power. A power converter may convert the first type of electrical power into a second type of electrical power. One or more light emitting devices may be powered with the second type of electrical power from the power converter to output light corresponding to the received ultrasonic energy waves by the at least one of the plurality of transducers to provide a visual indication of the ultrasonic energy waves.

According to an implementation of the disclosed subject matter, a method is provided that includes receiving, by at least at a plurality of transducers, ultrasonic energy waves and converting the ultrasonic energy waves into a first type of electrical power. The method includes converting, at a power converter, the first type of electrical power into a second type of electrical power, and powering one or more light emitting devices with the second type of electrical power from the power converter. The method includes outputting light, at the one or more light emitting devices, corresponding to the received ultrasonic energy waves by the at least one of the plurality of transducers to provide a visual indication of the ultrasonic energy waves.

According to an implementation of the disclosed subject matter, means for visually indicating of a focus and directionality of ultrasonic energy waves are provided, including a means for at least one of a plurality of transducers to receive ultrasonic energy waves and convert the ultrasonic energy waves into a first type of electrical power. A means for converting the first type of electrical power into a second type of electrical power may be provided. The implementation may include means for outputting light that may be powered with the second electrical power from the power converter to corresponding to the received ultrasonic energy waves by the at least one of the plurality of transducers to provide a visual indication of the ultrasonic energy waves.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for beamforming for wireless power transfer and providing a visual indication of the received wireless power according to an implementation of the disclosed subject matter.

FIG. 2 shows an example system suitable for beamforming for wireless power transfer according to an implementation of the disclosed subject matter.

FIG. 3 shows an example arrangement suitable for reception of ultrasonic energy waves for wireless power transfer and visualization thereof according to an implementation of the disclosed subject matter.

FIG. 4 shows an example system suitable for beamforming for wireless power transfer and providing a visual indication of the received wireless power according to an implementation of the disclosed subject matter.

FIG. 5 shows an example visualization of the reception of ultrasonic energy waves for wireless power transfer where no ultrasonic energy is being received by the transducers of the wireless power transfer device according to an implementation of the disclosed subject matter.

FIGS. 6-9 show example visualizations of the reception of ultrasonic energy waves for wireless power transfer where ultrasonic energy is received by at least one of the transducers of the wireless power transfer device according to implementations of the disclosed subject matter.

FIG. 10 shows an example method of visualizing a wireless power transfer according to an implementation of the disclosed subject matter.

FIG. 11 shows a computer according to an embodiment of the disclosed subject matter.

FIG. 12 shows a network configuration according to an embodiment of the disclosed subject matter.

### DETAILED DESCRIPTION

Implementations of the disclosed subject matter provide a visual indication of ultrasonic energy waves. In particular, implementations of the disclosed subject matter provide for visualization of the focus, directionality, dispersion pattern, strength, and/or coverage area of ultrasonic energy waves that are received by one or more transducers. The light output by the light emitting devices may correspond to the characteristics of the received ultrasonic energy waves. In some implementations, the visual indication may be used to adjust the positioning of a source and/or receiver of ultrasonic energy waves which may be used in energy transfer (e.g., for power applications), diagnostic testing, and the like. For example, the visual feedback from the light emitting devices may be relied upon so that a user, technician, administrator, or the like may adjust one or more settings of a controller of a transmitting wireless power transfer device to adjust phase, amplitude, and/or directionality of the ultrasonic energy waves being transmitted to a receiving wireless power transfer device.

In an implementation, an array of light emitting devices is arranged in an array that is parallel to an array of transducers. One or a group of light emitting devices are configured to produce output that corresponds to one or more characteristics of energy received by one or more transducers that are closest to the light emitting devices. For example, the output of light emitting devices in the lower right corner of a rectangular array of such devices reflects one or more characteristics of the energy received by transducers in the lower right corner of a rectangular array of transducers arranged parallel to the array of light emitting devices. For example, the two parallel arrays may occur in the form factor of a handheld device that can be moved in and out of an area to detect the presence and characteristics of a beam of otherwise invisible energy. In other implementations, the array of light emitting devices is entirely separate from the array of transducers. For example, the array of transducers may be in the form of a handheld, movable device while the light emitting devices may be a separate device that is wirelessly in communication with the transducer array.

In implementations of the disclosed subject matter, beamforming may be used in a wireless power transfer device. Power, in the form of ultrasonic energy waves, may be transferred from a transmitting transducer to a plurality of transducers to receive ultrasonic energy waves. The output phase and amplitude of the elements of a wireless power transfer device may be controlled so that the waveforms (e.g., ultrasonic energy waves) carrying the transmitted energy present a wave front with a coherent phase when they arrive at the elements of the wireless power transfer device intended to receive the wireless power (e.g., the plurality of transducers to receive the ultrasonic energy waves). The phase and amplitude of the elements of the transmitting wireless power transfer device may be controlled based on the relative positions of the wireless power transfer devices (e.g., the transmitting transducers) so that the wave front arrives at the receiving wireless power transfer device (e.g., the plurality of transducers to receive the ultrasonic energy waves) with a coherent phase regardless of the position of the receiving wireless power transfer device relative to the transmitting wireless power transfer device. The receiving wireless power transfer device (e.g., the plurality of transducers to receive the ultrasonic energy waves) may include a power converter to convert the ultrasonic energy waves received by at least one of the plurality of transducers into electrical power. For example, the transducers may convert the ultrasonic energy waves into a first type of electrical power (e.g., an alternating current (AC) electrical power), and the power converter may convert the first type of electrical power (e.g., AC electrical power) into a second type of electrical power (e.g., direct current (DC) electrical power). In implementations of the disclosed subject matter, one or more light emitting devices may be powered with the electrical power (e.g., the second type of electrical power) from the power converter to output light corresponding to the received ultrasonic energy by at least one of the plurality of transducers to provide a visual indication of the ultrasonic energy waves. The one or more light emitting devices may output light corresponding to the received ultrasonic energy waves to provide a visual indication of the focus and directionality of the ultrasonic energy waves. The light output by the light emitting devices may provide a visual indication of the dispersion pattern, strength, and/or coverage area of the received ultrasonic energy waves.

A wireless power transfer device may be any suitable device that may be used for wireless power transfer. For example, a wireless power transfer device may be an ultrasonic transmitter, which may include a number of individual transducer elements. Each transducer element may be a separate vibrator of any suitable type, such as, for example, a piezoelectric cantilever with a free end and a fixed end. The ultrasonic transmitter may transmit wireless power through ultrasonic waves generated by the transducer elements. The transducer elements of an ultrasonic transmitter may be covered with a membrane, which may be any suitable material for assisting in the translation of the movement of the cantilever to movement of the transmission medium, which may be the air. A wireless power transfer device may be a radio frequency (RF) transmitter, which may transmit wireless power using RF waves, or an optical transmitter which may transmit wireless power using light from any suitable part of the light spectrum, including, infrared and ultraviolet light. A wireless power transfer device may be capable of sending wireless power, receiving wireless power, sending wireless communications, receiving wireless communications, and performing other functions, such as, for example, imaging and obstacle detection.

In some implementations of the disclosed subject matter, wireless power may be transferred between wireless power transfer devices. For example, a transmitting wireless power device may transfer power to a receiving wireless power transfer device which may provide power to any suitable electronic or electric device, such as a smartphone, laptop, tablet, wearable electronic device, sensor package, electrical motor, or other electrical appliance. The power received by the wireless power transfer device may be used to directly power a device, or may be stored, for example, in a battery, capacitor, or any other suitable form of electrical or power storage. The transmitting wireless power transfer device may draw power from any suitable source, such as, for example, an AC or DC current generated in any suitable manner, including from a battery, or from an outlet connected to a power generator. The efficiency with which wireless power is transmitted between a transmitting wireless power transfer device and a receiving wireless power transfer device may be affected by the properties of the wave front that arrives at the elements of the receiving wireless power transfer device, and the variation in the properties of the wave front as experienced at those elements. A wave front which presents a coherent phase across the elements of the receiving wireless power transfer device may improve the efficiency of the transfer of wireless power, as less rectification of the current generated by the received power may be needed. The light emitting devices that are powered with the electrical power from the power converter may output light corresponding to the received ultrasonic energy by the transducers to provide a visual indication of the ultrasonic energy waves. In some implementations, the light emitting devices may output light corresponding to the received ultrasonic energy waves to provide a visual indication of the focus and directionality of the ultrasonic energy waves.

The receiving wireless power transfer device (e.g., plurality of transducers to receive the ultrasonic energy waves) may be a target of wireless power from a transmitting wireless power transfer device. The beam received by the receiving wireless power transfer device may be continuous, or may be pulsed. For example, the receiving wireless power transfer device may be a smartphone or sensor-based device, and the transmitting wireless power transfer device may be a wall panel plugged into an outlet. In implementations of the disclosed subject matter, the light emitting devices of the receiving wireless power transfer device may be used to provide a visual indication the ultrasonic energy waves, and enable positioning of the transmitting wireless power transfer device. For example, the light emitting devices may output light corresponding to the received ultrasonic energy waves to provide a visual indication of the focus and directionality of the ultrasonic energy waves, and enable positioning of the transmitting wireless power transfer device.

In some implementations, the amplitude of the waveforms transmitted from the elements of the transmitting wireless power transfer device may be the same or may vary to optimize the energy transferred to the receiving device. The wave front of the beam from the transmitting wireless power transfer device may have a uniform amplitude across the elements of the receiving wireless power transfer device.

The beam transmitted from the receiving wireless power transfer device may be continuous or may be pulsed, and may be transmitted at any suitable time or interval. For example, the receiving wireless power transfer device may transmit the beam originating with coherent phase before receiving any wireless power from the transmitting wireless power transfer device, or once, or at regular intervals while receiving wireless power.

The position of a reception area of the receiving wireless power transfer device may be determined based on the light emitted from the light emitting devices that provide a visual indication of the ultrasonic energy waves. For example, the position of the reception area may be determined by the light emitting devices that output light corresponding to the received ultrasonic energy waves to provide a visual indication of the focus and directionality of the ultrasonic energy waves.

In some implementations, the transmitting wireless power transfer device may request, or receive without requesting, position data from the receiving wireless power transfer device, such as, for example, accelerometer or gyroscope data, which may indicate the orientation of the receiving wireless power transfer device relative to the transmitting wireless power transfer device. Any suitable form of range finding may be used to determine the distance between the receiving wireless power transfer device and the transmitting wireless power transfer device. For example, elements of the transmitting wireless power transfer device may transmit waveforms at a given time. The receiving wireless power transfer device may receive the waveforms, and may send an indication of the time at which the waveforms were received to the transmitting wireless power transfer device using any suitable form of communication. The time-of-flight of the waveforms between the transmitting and receiving wireless power transfer devices and the type of wireless power transfer may be used to determine the distance between transmitting and receiving wireless power transfer devices. The transmitting wireless power transfer device may sweep the transmission of a beam over a given area, for example, using pulsed transmission at various angles, until the receiving wireless power transfer device indicates it received the beam, allowing for the determination of the direction of the receiving wireless power transfer device relative to the transmitting wireless power transfer device. The positon of the receiving wireless power transfer device may also be determined by, for example, separate tracking or range-finding devices on either or both of the transmitting and receiving wireless power transfer devices. The position of the receiving wireless power transfer device may include the positions and orientations of elements on the receiving wireless power transfer device. In this implementation, the light emitting devices may be used to visually determine whether the transmitting wireless power transfer device is transmitting ultrasonic energy waves according to the received position information from the receiving wireless power transfer device. In some implementations, the output of the light emitting devices may be used to determine the accuracy of the beam forming and directionality of the transmission of ultrasonic energy waves by the transmitting wireless power transfer device.

The transmitting wireless power transfer device may simulate the beam and its wave front in any suitable manner. For example, the transmitting wireless power transfer device may simulate a waveform transmitted from each element of the receiving wireless power transfer device. The beam may be simulated as being continuous or pulsed. The simulated waveforms may be simulated as having coherent phase at their origin. The transmitting wireless power transfer device may simulate the propagation of the waveforms from each element of the receiving wireless power transfer device, including any interference between the waveforms as they propagate away from the receiving wireless power transfer device. The simulation may be based on, for example, the type of wireless power transfer being used and the medium through which the waveforms travel, and may attempt to account for losses of amplitude during propagation. In some implementations, the light emitting devices may be included with the wireless power transfer device to output light that corresponds to the simulated waveform.

If ultrasonic waves are used to transfer wireless power, the simulated waveforms may be simulated traveling through the air, and the simulation may account for the temperature and density of the air, for example, as determined by a thermometer and barometer of the transmitting or receiving wireless power transfer devices. The simulation may attempt to account for any loss in amplitude of the ultrasonic waves between the receiving and transmitting wireless power transfer devices due to transfer of energy to the air. The simulation may also account for the relative of position of the elements of the receiving wireless power transfer device and the directivity of waveforms generated by the elements. For example, the elements may be arranged in any suitable configuration, and may be arranged on any number of flat or curved planes of any suitable type. For example, the elements of the receiving wireless power transmitter may be arranged on the curved back of a smartphone, such that waveforms generated by the elements may not be directed in the same direction. In some implementations, light emitting devices may be used to visually indicate the directivity of the simulated waveforms, and/or any simulated loss of amplitude of a waveform (e.g., because of temperature and/or density of the air).

The elements of the transmitting wireless power transfer device may transmit waveforms that are the same as the elements' simulated experiences of the wave front of the simulated beam from the receiving wireless power transfer device. For example, the transmitting wireless power transfer device may cause the elements to transmit have the same phase differences as the elements' simulated experiences of the wave front of the simulated beam. Any phase difference between the waveforms transmitted by any two elements of the transmitting wireless power transfer device may be based on the difference between the phases of the wave front of the simulated beam as experienced in simulation at the two elements. Transmitting waveforms using the experienced phases of the wave front of the simulated beam may result in the beam from the transmitting wireless power transfer device having a coherent phase wave front across the elements of the receiving wireless power transfer device. The beam may also be focused on the receiving wireless power transfer device, for example, reducing the amount of power from the elements of the transmitting wireless power transfer device that does not reach the receiving wireless power transfer device, for example, due to being part of the beam that misses the receiving wireless power transfer device. In implementations of the disclosed subject matter, the light emitting devices may be used to visually indicate whether the beam is received by the elements of the receiving wireless power transfer device. The visualization may indicate whether one or more beams are focused on, reaching, and/or missing the receiving wireless power transfer device, and the location of the beam reception.

The amplitude of the waveforms transmitted from the elements of the transmitting wireless power transfer device may be the same, or may be based on the amplitude of the wave front of the simulated beam as experienced in simulation by those elements. The light emitting devices may output light that indicates the amplitude of the received ultrasonic energy waves. For example, the light emitting devices may output a particular wavelength or range of wavelengths when the amplitude of the wave exceeds a predetermined amplitude.

In some implementations, the receiving wireless power transfer device may provide feedback to the transmitting wireless power transfer device. The feedback may be provided using any suitable form of communication. For example, the communication may be in-band, using the elements of the receiving wireless power transfer device to transmit data to the elements of the transmitting wireless power transfer device, or out-of-band, using, for example, Bluetooth, Wi-Fi or cellular communications, or any other suitable form of wireless or wired communication. The feedback from the receiving wireless power transfer device may indicate the phase and amplitude of the wave front of the beam formed by the waveforms from the elements of the transmitting wireless power transfer device as measured at the elements of the receiving wireless power transfer device. In some implementations, the feedback may include the light output from the light emitting devices that corresponds to the received ultrasonic waves. In some implementations, the feedback may include the light output from the light emitting devices to indicate the focus and directionality of the received ultrasonic waves. The wavelength or range of wavelengths of the light output by the light emitting devices may be based on the amplitude and/or phase of the received wave. One or more light emitting devices and/or elements of the light emitting devices may output light that corresponds to the received wave. For example, the light emitting devices and/or elements of the light emitting devices may output light according to the focus and/or directionality of the received wave. The transmitting wireless power transfer device may use the feedback to adjust the phases and amplitudes used by its elements, for example, to reduce any unintentional phase incoherence across the elements of the receiving wireless power transfer device as indicated by the feedback. In some implementations, an administrator (e.g., an installer, a technician, or the like) may rely upon the visual feedback from the light emitting devices to adjust one or more settings of a controller of the transmitting wireless power transfer device to adjust phase, amplitude, and/or directionality of the ultrasonic energy waves being transmitted to the receiving wireless power transfer device.

In some implementations, the feedback (which may include visual feedback from the light emitting devices) may indicate to the transmitting wireless power transfer device that the receiving wireless power transfer device requires less power, for example, due to a battery being charged to some threshold level. The transmitting wireless power transfer device may change the phase and amplitude used by its elements, and the number of elements used, so that the transferred power can be used to trickle charge the battery of the receiving wireless power transfer device. The phases and amplitudes used may be chosen for efficiency, rather than for maximum power transfer or for maintaining a coherent phase wave front across the elements of the receiving wireless power transfer device.

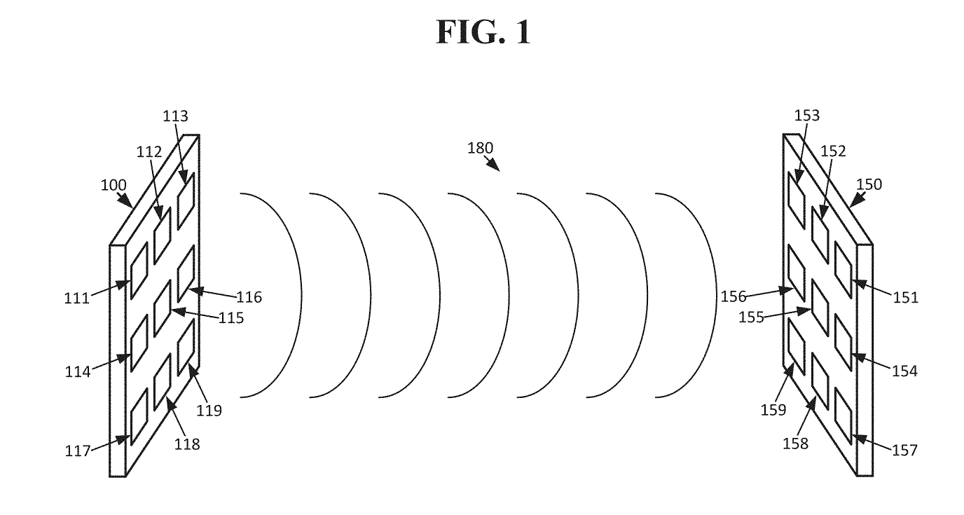

FIG. 1 shows an example system suitable for beamforming for wireless power transfer and providing a visual indication of the received wireless power according to an implementation of the disclosed subject matter. A transmitting wireless power transfer device 100 may include elements 111, 112, 113, 114, 115, 116, 117, 118, and/or 119, which may be capable of transmitting and/or receiving wireless power. The transmitting wireless power transfer device 100 may be a device for transmitting wireless power, which may draw power from a source of energy such as a power outlet connected to any suitable power source, a battery, or any other source of energy, and may be designed to provide power to other electronic or electric devices. The elements 111, 112, 113, 114, 115, 116, 117, 118, and/or 119 may be, for example, ultrasonic transducer elements, RF transducer elements, optical transducer elements, or any other element type suitable for the transmission of wireless power. In some implementations, the elements 111, 112, 113, 114, 115, 116, 117, 118, and/or 119 may be capable of operating in both a transmitting and receiving mode. In a transmitting mode, the elements 111, 112, 113, 114, 115, 116, 117, 118, and/or 119 may generate waveforms, for example, ultrasonic sound waves (e.g., ultrasonic energy waves), RF waves, or light waves, which may carry energy to a receiving wireless power transfer device 150. In a receiving mode, the elements 111, 112, 113, 114, 115, 116, 117, 118, and/or 119 may react to receiving waveforms, for example, ultrasonic sound waves, RF waves, or light waves generated elsewhere by converting the waveforms into electrical signals. For example, an ultrasonic transducer may use a piezoelectric flexure which may vibrate at ultrasonic frequencies when an appropriate electrical signal is supplied, generating an ultrasonic sound wave, and may be vibrated at ultrasonic frequencies when receiving an ultrasonic sound wave, generating an electrical signal. In some implementations, the elements 111, 112, 113, 114, 115, 116, 117, 118, and/or 119 may be optimized for the transmitting of wireless power.

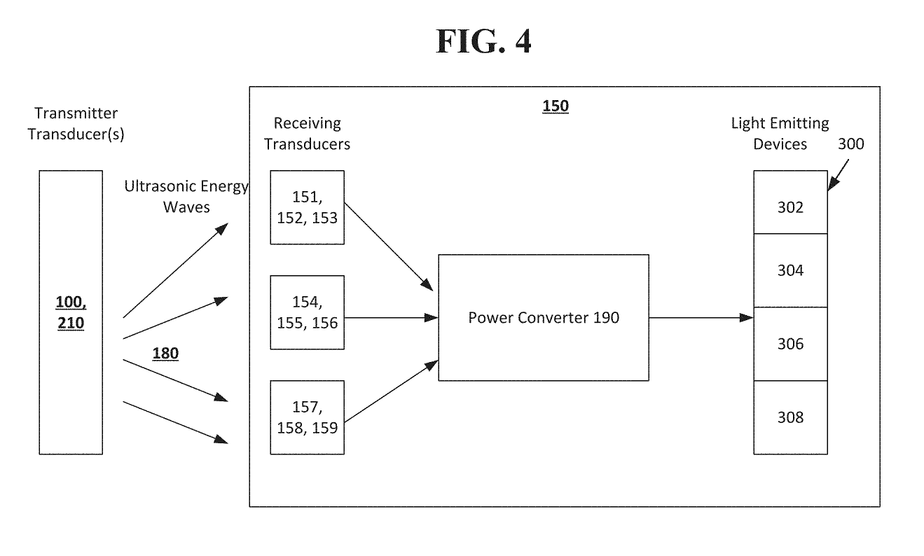

A receiving wireless power transfer device 150 may include elements 151, 152, 153, 154, 155, 156, 157, 158, and/or 159, which may be capable of receiving and/or transmitting wireless power. The receiving wireless power transfer device 150 may be a component of, or connected to, an electronic or electric device to which the receiving wireless power transfer device 150 may supply power. For example, the receiving wireless power transfer device 150 may be part of a smartphone or other electronic device, and may supply electricity to the smartphone's battery. The elements 151, 152, 153, 154, 155, 156, 157, 158, and/or 159 may be, for example, ultrasonic transducer elements, RF transducer elements, optical transducer elements, or any other element type suitable for the transmission of wireless power. In some implementations, the receiving wireless power transfer device 150 may include at least one power converter 190 and light emitting devices 300, which may include elements 302, 304, 306, and/or 308 to output light based on the power converted from a received beam 180 (e.g., ultrasonic energy waves), as shown in FIG. 4.

The elements 151, 152, 153, 154, 155, 156, 157, 158, and/or 159 may be of the same type, or of a similar type with optimizations for the specific role of the element, as the elements 111, 112, 113, 114, 115, 116, 117, 118, and 119, in order to allow the transfer of wireless power between the transmitting wireless power transfer device 100 and the receiving wireless power transfer device 150. For example, an element of the wireless power transfer device 100 may be optimized for power transmission, while an element of the receiving wireless power transfer device 150 may be optimized for power receiving. The light emitting devices 300 shown in FIG. 4 of the receiving wireless power transfer device 150 may be optimized for outputting light based on a received ultrasonic energy wave (e.g., beam 180) by the elements 151, 152, 153, 154, 155, 156, 157, 158, and/or 159.

The elements 111, 112, 113, 114, 115, 116, 117, 118, and/or 119 may generate waveforms, for example, based on received electrical signals. For example, a controller may provide electrical signals to control the generation of waveforms by the elements 111, 112, 113, 114, 115, 116, 117, 118, and/or 119. The waveforms may form a beam 180, carrying energy to the receiving wireless power transfer device 150. The beam 180 may be, for example, a beam of ultrasonic sound waves (e.g., ultrasonic energy waves), RF waves, or light. A wave front of the beam 180 may arrive at the elements 151, 152, 153, 154, 155, 156, 157, 158, and/or 159, resulting in the generation of electricity (e.g., electrical power) by the receiving wireless power transfer device 150 from the energy carried by the beam 180. For example, the elements 151, 152, 153, 154, 155, 156, 157, 158, and/or 159 may convert the beam 180 into a first type of electrical power (e.g., AC electrical power), a power converter 190 (as shown in FIG. 4) may convert the first type of electrical power into a second type of electrical power (e.g., DC electrical power), which may be used by the elements 302, 304, 306, and/or 308 of the light emitting device 300 to output light.

The efficiency with which the receiving wireless power transfer device 150 generates electricity (e.g., with the power converter 190) from the beam 180 may depend on, for example, whether the beam 180 is directed at the receiving wireless power transfer device 150, how focused the beam is on the receiving wireless power transfer device 150, and/or the phase coherence of the wave front of the beam 180 across the elements 151, 152, 153, 154, 155, 156, 157, 158, and/or 159. The transmitting wireless power transfer device 100 may control the steering and focus of the beam 180 and the phase of the wave front across the elements 151, 152, 153, 154, 155, 156, 157, 158, and/or 159 by controlling the phases of the waveforms transmitted by the elements 111, 112, 113, 114, 115, 116, 117, 118, and/or 119. As described below, the light emitting device 200 may output light corresponding to the received ultrasonic energy from the beam 180. In some implementations the light emitting device 200 may output light corresponding to the focus and/or directionality of the received ultrasonic energy by at least one of the plurality of transducers to provide a visual indication of the focus and/or directionality (e.g., steering) of the beam 180 (e.g., ultrasonic energy waves).

In some implementations, the elements 111, 112, 113, 114, 115, 116, 117, 118, and/or 119 of the transmitting wireless power transfer device 100 and the elements 151, 152, 153, 154, 155, 156, 157, 158, and/or 159 may be used for in-band communication. For example, the transmitting wireless power transfer device 100 and the receiving wireless power transfer device 150 may communicate using the waveforms generated by their respective elements. The transmitting wireless power transfer device 100 and receiving wireless power transfer device 150 may also communicate out-of-band, for example, using a Bluetooth, Wi-Fi, cellular, or other suitable wireless connection, or a suitable wired connection.

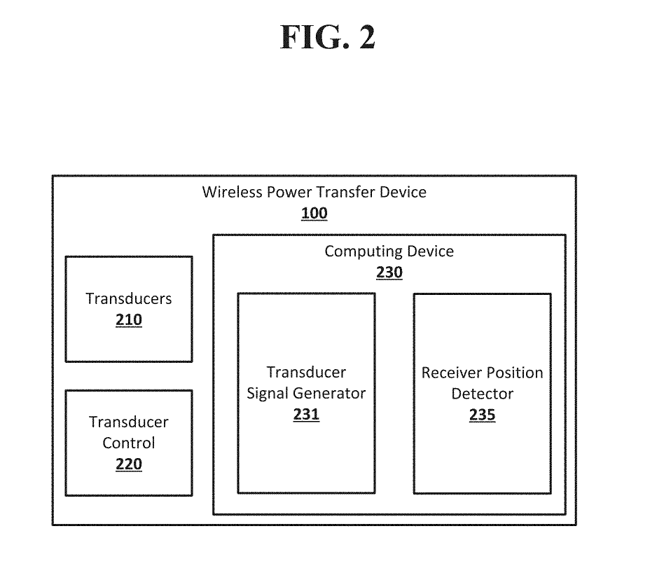

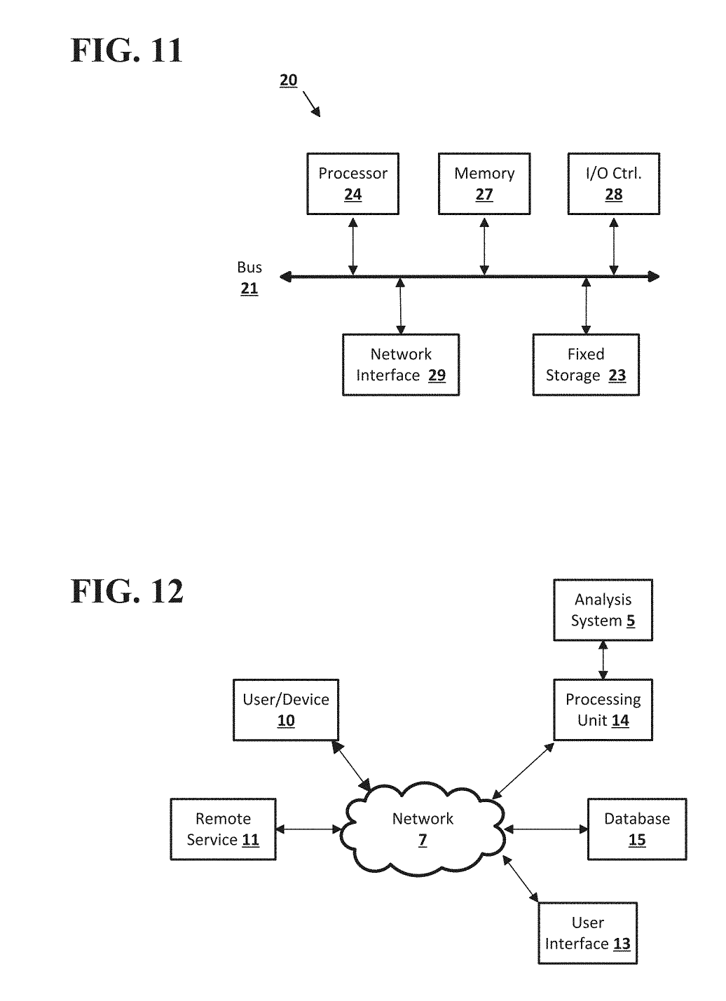

FIG. 2 shows an example system suitable for beamforming for wireless power transfer according to an implementation of the disclosed subject matter. The transmitting wireless power transfer device 100 may include transducers 210, transducer control 220, and a computing device 230, which may include a transducer signal generator 231 and receiver position detector 235. The transducers 210 may be any suitable transducers for the transmission of wireless power, such as, for example, the elements 111, 112, 113, 114, 115, 116, 117, 118, and/or 119, as shown in FIG. 1 and described above. The transducer control 220 may be any suitable combination of hardware and software for controlling the transducers 210, for example, based on control signals from the transducer signal generator 231. The computing device 230 may be any suitable computing device, such as, for example, a computer 20 as described in FIG. 11, or component thereof, for implementing the transducer signal generator 231 and the receiver position detector 235. The computing device 230 may be a single computing device, or may include multiple connected computing devices, and may be, for example, a laptop, a desktop, an individual server, a server farm, or a distributed server system, or may be a virtual computing device or system. The computing device 230 may be part of a computing system and network infrastructure, or may be otherwise connected to the computing system and network infrastructure. The transducer signal generator 231 may be any suitable combination of hardware and software on the computing device 130 for generating control signals that may be used to control the transducers 210. The receiver position detector 235 may be any suitable combination of hardware and software for detecting the position of a receiving wireless power transfer device, such as the receiving wireless power transfer device 150.

The transducers 210 may be any suitable transducers for the transmission of wireless power, such as, for example, the elements 111, 112, 113, 114, 115, 116, 117, 118, and/or 119. The transducers 210 may be, for example, ultrasonic transducers, RF transducers, or optical transducers. The transmitting wireless power transfer device 100 may include any suitable number of transducers 210, arranged in any suitable manner. For example, the transducers 210 may all be arranged in grid pattern on the same plane, may be arranged across multiple planes at various angles, or may be arranged on curved or spherical surfaces of the transmitting wireless power transfer device 100. The transducers 210 may operate in receiving mode or a transmitting mode. In some implementations, the transducers 210 may operate in both modes at the same time, for example, with certain transducers operating in a receiving mode while others operate in a transmitting mode.

The transducer control 220 may be any suitable combination of hardware and software for controlling the transducers 210, for example, based on control signals from the transducer signal generator 231. The transducer control 220 may include any suitable electronics, including general purpose or specialized processors and controllers, circuitry, and electrical connections to connect the computing device 230 to the transducers 210. The transducer control 220 may also include any suitable electronics, including general purpose or specialized processors and controllers, circuitry, and electrical connections to handle electrical signals generated by any of the transducers 210 operating in a receiving mode. For example, the transducer control 220 may include voltage rectifiers and transformers to convert an electrical signal generated based on received power to a specified current type and voltage, and to direct the electrical signal to an appropriate form of energy storage. The transducer control 220 may also, in conjunction with the computing device 230, interpret in-band communications received at the transducers 210. The transducer control 210 may be able to determine the phase and amplitude of a wave front as experienced at any of the transducers 210 when operating in a receiving mode. The phase determination may be made relative to other transducers 210 which may receive the same wave front, and may be made using any suitable measurements taken over any suitable period of time at any suitable intervals.

The computing device 230 may be a single computing device, or may include multiple connected computing devices, and may be, for example, a laptop, a desktop, an individual server, a server farm, or a distributed server system, or may be a virtual computing device or system. The computing device 230 may be part of a computing system and network infrastructure, or may be otherwise connected to the computing system and network infrastructure. The computing device 230 may be part of the same physical device as the transducers 210, or may be part of a separate device connected to the transducer 210 through the transducers control 220 through, for example, a wired or wireless connection.

The transducer signal generator 231 may be any suitable combination of hardware and software on the computing device 230 for generating control signals that may be used to control the transducers 210. The transducer signal generator 231 may generate control signals which may be used to control the waveforms generated by the transducers 210. Control signals generated by the transducer signal generator 231 may, for example, indicate the phase, frequency, and amplitude of the waveforms to be generated by the transducers 210. The transducer signal generator 231 may use phases and amplitudes of a received wave front, as determined at the transducers 210, to generate control signals, for example, using the phase differences as determined at the transducers 210. The transducer signal generator 231 may determine when the transducers 210 enter receiving and transmitting modes.

The receiver position detector 235 may be any suitable combination of hardware and software for detecting the position of a receiving wireless power transfer device, such as the receiving wireless power transfer device 150. The position of the receiving wireless power transfer device 150, which may be an intended target of wireless power from the transmitting wireless power transfer device 100, may include the distance from the transmitting wireless power transfer device 100, angles of a vector between the transmitting wireless power transfer device 100 and receiving wireless power transfer device 150, and angle of orientation of the receiving wireless power transfer device 150, including the orientation of any transducers, for example, the elements 151, 152, 153, 154, 155, 156, 157, 158, and/or 159, of the receiving wireless power transfer device 100. In some implementations, the receiver position detector 235 may receive position data from the receiver wireless power transfer device 150, including, for example, gyroscope and accelerometer data. The receiver position detector 235 may use the transducers 210 to locate the receiving wireless power transfer device 150, for example, transmitting the beam 180, with, for example, a narrow focus, at various angles until the receiving wireless power transfer device 150 responds that it detected the beam 180. The receiver position detector 235 may also use any other separate tracking or range-finding devices to locate the position of the receiving wireless power transfer device 150.

In some implementations, the receiver position detector 235 may utilize light output from light emitting devices 300 to locate the position of the receiving wireless power transfer device 150. The transducer control 220 and/or the computing device 230 may control the operation of the transducers 210 and/or the transducer signal generator 231 to output a beam 180 (e.g., ultrasonic energy waves) based on light output from the light emitting devices 300 that corresponds to the received ultrasonic energy by at least one of the plurality of transducers. For example, the transducer control 220 and/or the computing device 230 may control the operation of the transducers 210 and/or the transducer signal generator 231 to output the beam 180 based on the focus and directionality of the received ultrasonic energy by at least one of the plurality of transducers to provide a visual indication of a focus and directionality of the ultrasonic energy waves.

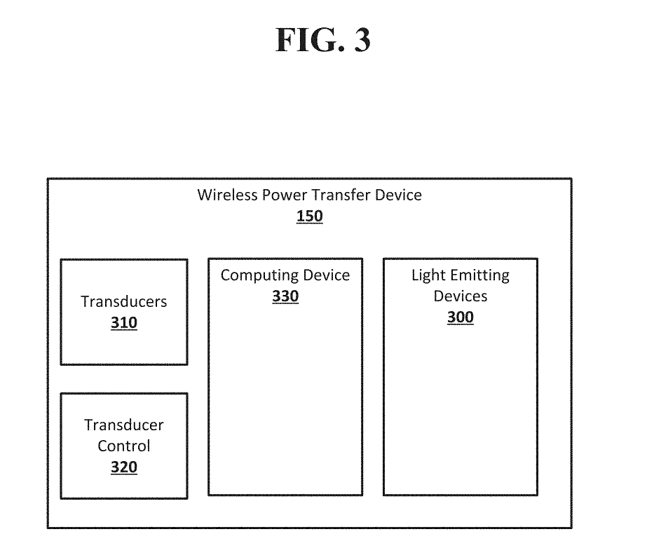

FIGS. 3-4 show example arrangements suitable for reception of ultrasonic energy waves for wireless power transfer and visualization thereof according to an implementation of the disclosed subject matter. The receiving wireless power transfer device 150 may include transducers 310, which may include, for example, the elements 151, 152, 153, 154, 155, 156, 157, 158, and/or 159. The transducers 310 may receive ultrasonic energy waves from at least one of the elements 111, 112, 113, 114, 115, 116, 117, 118, and 119 of the transducers 210 of the wireless power transfer device 100. The transducer control 320 and/or the computing device 330 may control the conversion of the ultrasonic energy waves (beam 180) received by the transducers 310 into an electrical signal (e.g., electrical power) which may be used to control the operation of the light emitting devices 300 to output light (e.g., one or more of the elements 302, 304, 306, and/or 308 shown in FIG. 4). For example, the ultrasonic energy received by the transducers 310 may be converted into an AC (alternating current) signal (e.g., a first type of electrical power), and then converted into a DC (direct current) signal (e.g., with a rectifier to form a second type of electrical power) by at least one of the transducer control 320 and/or the computing device 330 to form the electrical signal and/or electrical power that may drive the light emitting devices 300. One or more rectifiers and transformers may be used to convert the ultrasonic energy waves to an electrical signal to a specified current type and voltage.

The light emitting devices 300 that output light and provide a visual indication of the received ultrasonic energy waves (e.g., during wireless power transfer) may include one or more light emitting diodes (LEDs), organic light emitting diodes (OLEDs), liquid crystal displays (LCDs), fluorescent light sources, incandescent light sources, and/or other suitable light sources. In some implementations, one or more filters (e.g., color filters) may be used to change the color (i.e., wavelength) of the light output by the light emitting devices. For example, a different wavelength or range of wavelengths of light may be used to represent an intensity or range of intensities (e.g., amplitudes) of the received ultrasonic energy waves. For example, in an implementation, a LED may emit red light when power in a lower range is received by one or more transducers corresponding to the LED; a yellow light when power in a middle range is received by one or more transducers corresponding to the LED; and a blue light when power in a higher range is received by one or more transducers corresponding to the LED.

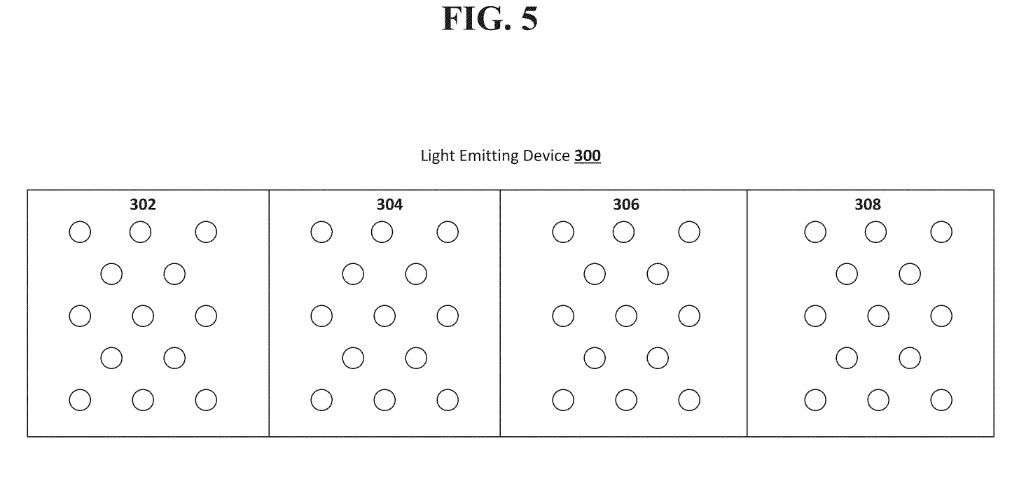

In some implementations, one or more of the transducers 310 may generate a differential signal based on the received ultrasonic energy waves from the beam 180. The transducer control 320 and/or the computing device 330 may include a rectifier circuit to convert the AC signal output from the one or more of the transducers 310 to a DC signal. In some implementations, as shown in FIG. 4, a power converter 190 (e.g., that may be part of or coupled to transducer control 320 and/or the computing device 330) may convert the AC signal (e.g., a first type of electrical power) into a DC signal (e.g., with a rectifier and/or transformer and where the DC signal may be a second type of electrical power) by at least one of the transducer control 320 and/or the computing device 330 to form the electrical signal that may drive the light emitting devices 300. The transducer control 320 and/or the computing device 330 may determine which, of the one or more of the elements 302, 304, 306, and/or 308 of the light emitting device 300 to control based on the DC signal. The one or more elements 302, 304, 306, and/or 308 of the light emitting device 300 may output light based on the DC signal. Which of the one or more elements 302, 304, 306, and/or 308 of the light emitting device 300 output light may be based on which of the elements 151, 152, 153, 154, 155, 156, 157, 158, and/or 159 of the transducers 310 receive the beam 180, as discussed below in connection with FIGS. 5-8.

FIG. 5 shows an example visualization of the reception of ultrasonic energy waves for wireless power transfer where no ultrasonic energy is being received by the transducers of the wireless power transfer device according to an implementation of the disclosed subject matter. For example, when none of the elements 151, 152, 153, 154, 155, 156, 157, 158, and/or 159 of the transducers 310 receive beam 180, no ultrasonic energy can be converted into a DC signal, and thus none of the elements 302, 304, 306, and/or 308 of the light emitting device 300 may output light. This may indicate that either none of the elements 111, 112, 113, 114, 115, 116, 117, 118, and/or 119 of the transducers 210 of the wireless power transfer device 100 and transmitting ultrasonic energy waves, or that none of the 111, 112, 113, 114, 115, 116, 117, 118, and/or 119 are directing ultrasonic energy towards the elements 151, 152, 153, 154, 155, 156, 157, 158, and/or 159 of the transducers 310. Alternatively, this may indicate that the magnitude of the ultrasonic energy being received by one or more of the elements 151, 152, 153, 154, 155, 156, 157, 158, and 159 is not sufficient to power one or more elements 302, 304, 306, and/or 308 of the light emitting device 300.

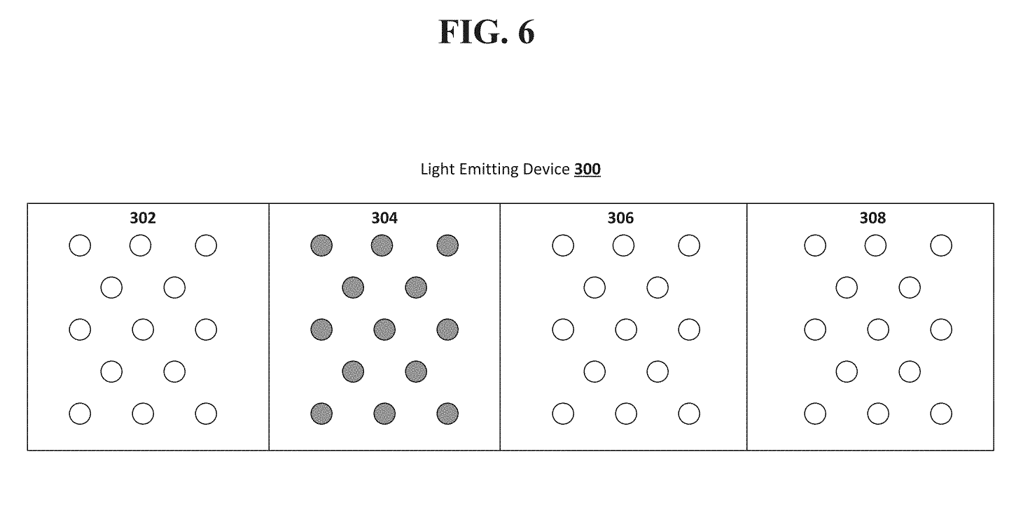

FIG. 6 shows an example visualization of the reception of ultrasonic energy waves for wireless power transfer where ultrasonic energy is received by at least one of the transducers of the wireless power transfer device according to an implementation of the disclosed subject matter. For example, when one or more of the elements 151, 152, 153, 154, 155, 156, 157, 158, and/or 159 of the transducers 310 receive beam 180, the ultrasonic energy may be converted into a DC signal, which may power the light emitting device 300. In the example shown in FIG. 6, element 304 of the light emitting device 300 may output light based on at least one of the elements 151, 152, 153, 154, 155, 156, 157, 158, and/or 159 receiving ultrasonic energy waves and the generation of a DC signal by the wireless power transfer device 150. Element 304 may include a plurality of light emitting devices. In the example shown in FIG. 6, all of light emitting devices of element 304 may output light. The element 304 which emits light may correspond to a position of at least one of the elements 151, 152, 153, 154, 155, 156, 157, 158, and/or 159 of the transducers 310 that receive the ultrasonic energy waves.

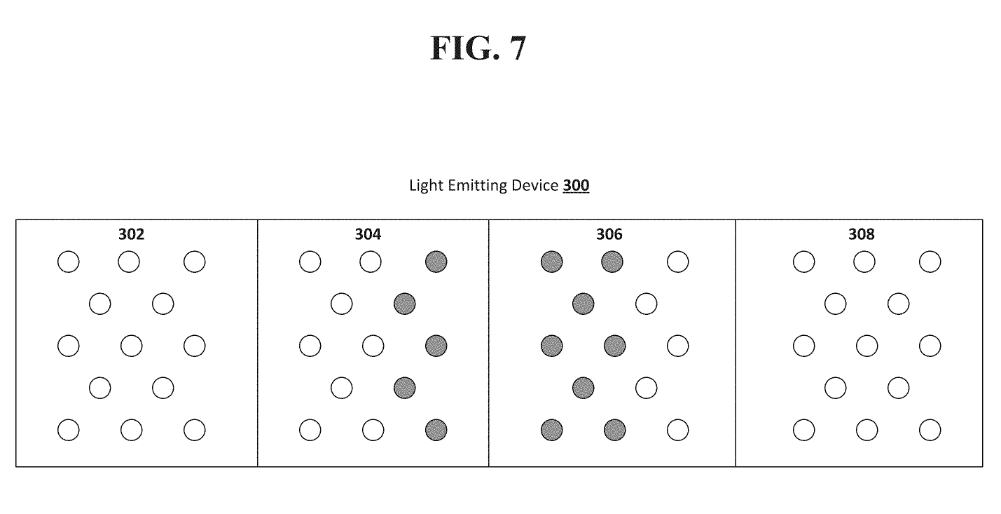

FIG. 7 shows an example visualization of the reception of ultrasonic energy waves for wireless power transfer where ultrasonic energy is received by at least one of the transducers of the wireless power transfer device according to an implementation of the disclosed subject matter. For example, when one or more of the elements 151, 152, 153, 154, 155, 156, 157, 158, and/or 159 of the transducers 310 receive beam 180, the ultrasonic energy may be converted into a DC signal, which may power the light emitting device 300. In the example shown in FIG. 7, portions of elements 304 and 306 of the light emitting device 300 may output light based on at least one of the elements 151, 152, 153, 154, 155, 156, 157, 158, and/or 159 receiving ultrasonic energy waves and the generation of a DC signal by the wireless power transfer device 150. The portion of elements 304 and 306 which emit light may correspond to a position of at least one of the elements 151, 152, 153, 154, 155, 156, 157, 158, and/or 159 of the transducers 310 that receive the ultrasonic energy waves.

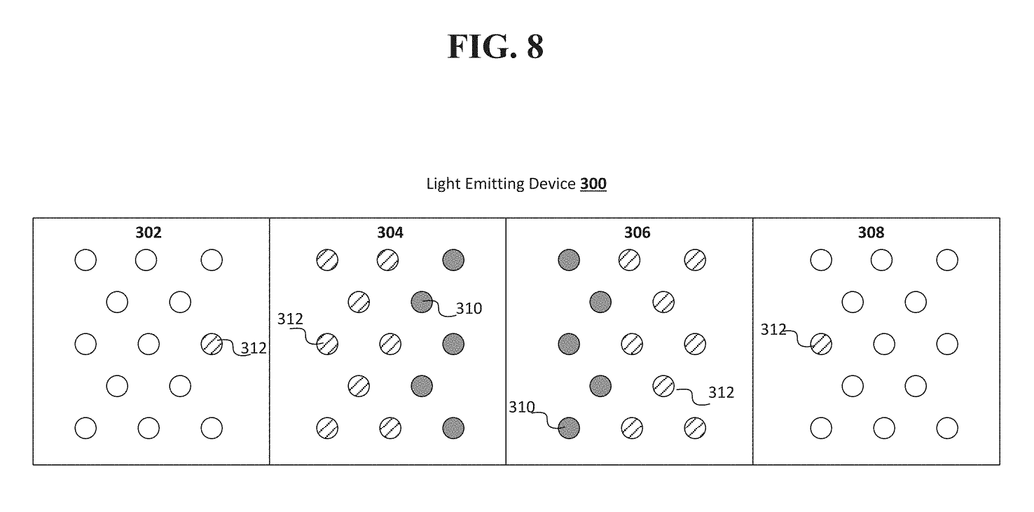

FIG. 8 shows an example visualization of the reception of ultrasonic energy waves for wireless power transfer where ultrasonic energy is received by at least one of the transducers of the wireless power transfer device according to an implementation of the disclosed subject matter. For example, when one or more of the elements 151, 152, 153, 154, 155, 156, 157, 158, and/or 159 of the transducers 310 receive beam 180, the ultrasonic energy may be converted into a DC signal, which may power the light emitting device 300. In the example shown in FIG. 8, portions of elements 302, 304, 306, and 308 of the light emitting device 300 may output light based on at least one of the elements 151, 152, 153, 154, 155, 156, 157, 158, and/or 159 receiving ultrasonic energy waves and the generation of a DC signal by the wireless power transfer device 150. The portion of elements 302, 304, 306, and 308 which emit light may correspond to a position of at least one of the elements 151, 152, 153, 154, 155, 156, 157, 158, and/or 159 of the transducers 310. In the example shown in FIG. 8, portions of elements 304 and 306 (e.g., such as portion 310) may emit light at a greater intensity and/or having a greater optical power than other portions of elements 302, 304, 306, and/or 308, which may emit light, but at a reduced intensity and/or optical power (e.g., such as shown by element 312). The intensity and/or optical power of the light output by the portion of the elements 302, 304, 306, and/or 308 may correspond to the intensity and/or magnitude of the ultrasonic energy waves received by one or more of the elements 151, 152, 153, 154, 155, 156, 157, 158, and/or 159 of the transducers 310. In some implementations, the color of light emitted by element 310 may be different than that emitted by element 312. That is, the wavelength or range of wavelengths of light emitted by element 310 may be different from the wavelength or range of wavelengths emitted by element 312. The different colors of light emitted by the light emitting device 300 may indicate the magnitude of ultrasonic energy waves received by one or more of the elements 151, 152, 153, 154, 155, 156, 157, 158, and/or 159 of the transducers 310. That is, the color of light (e.g., the wavelengths or range of wavelengths) emitted by element 310 may represent a greater magnitude of received ultrasonic energy waves than the color of light emitted by the element 312. In an implementation, the color or intensity of light emitted by element 310 may indicate the phase at which energy is received by one or more corresponding transducers. For example, element 310 may emit a red light for ultrasonic energy being received with a phase of 0-60 degrees, yellow for 61-120 degrees and blue for 121-180 degrees. Element 310 may also be composed of a multicolor LED (in an implementation, a group of three LEDS, one red, one green and one blue) capable of generating a spectrum of colors from red to blue. A color (hue) for element 310 can be calculated by mapping the power level or phase detected in the corresponding transducers to a hue value that represents the wavelength of the color. Likewise, the saturation (chroma) and value (lightness or darkness) of the light output by element 310 can also be assigned based on the power level, phase, average power level, average phase and any other measurable characteristic of the power received by the corresponding transducer or transducers. For example, the average power received by a set of (one or more) transducers can be shown by changing the hue, saturation and/or color value of the LED.

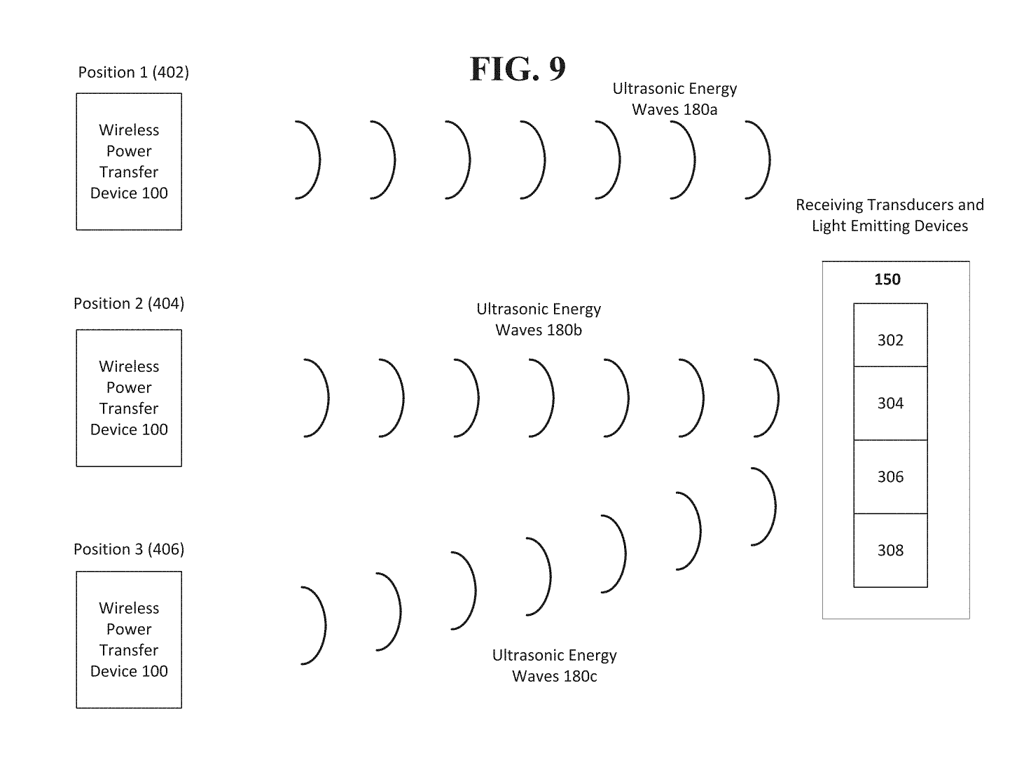

FIG. 9 shows another example visualization of the reception of ultrasonic energy waves for wireless power transfer where ultrasonic energy is received by at least one of the transducers of the wireless power transfer device according to an implementation of the disclosed subject matter. As described above, one or more of the elements 302, 304, 306, and/or 308 of the light emitting device 300 may output light based on at least one of the elements 151, 152, 153, 154, 155, 156, 157, 158, and/or 159 of the wireless power transfer device 150 receiving ultrasonic energy waves from the wireless power transfer device 100. The wireless power transfer device 150 may receive ultrasonic energy waves 180 based on the position of the wireless power transfer device 100 (e.g., position 402, 404, or 406), and the directionality of the ultrasonic energy waves 180 (e.g., waves 180a, 180b, 180c) output from the wireless power transfer device 100. For example, when the wireless power transfer device 100 is disposed in position 1 (402), the wireless power transfer device 150 may not receive any of the ultrasonic energy waves 180a emitted from the device 100, and the elements 302, 304, 306, and/or 308 may not output light (e.g., such as shown in FIG. 5). In another example, when the wireless power transfer device 100 is disposed in position 2 (404), the wireless power transfer device 150 may receive the ultrasonic energy waves 180b emitted from the device 100, and the elements 302, 304, 306, and/or 308 may output light (e.g., such as shown in FIG. 6, 7, or 8, as described above). In another example, when the wireless power transfer device 100 is disposed in position 3 (406), the wireless power transfer device 150 may receive a portion of the ultrasonic energy waves 180 emitted from the device 100, and the elements 302, 304, 306, and/or 308 may output light (e.g., such as shown in FIG. 7 as described above). That is, the visual indication provided by light output (or not output) by the light emitting device may provide information in determining a position of the wireless power transfer device in a room and/or other location to provide ultrasonic energy waves to power a device in the location of the wireless power transfer device 150.

That is, FIGS. 2-4 and 9 show example arrangements suitable for beamforming for wireless power transfer according to an implementation of the disclosed subject matter. The beam 180 or 180a transmitted by the wireless power transfer device 100 may not be aimed at the receiving wireless power transfer device 150. The direction of the beam 180 may depend on the locations of the transducers 210 on the wireless power transfer device 100 that are outputting the beam 180 or 180a relative to the locations of the transducers 310 on the receiving wireless power transfer device 150. For example, if the transducers 310 are located in a grid on a flat plane, the beam 180 may propagate outward from the flat plane. As long as at least one of the elements 111, 112, 113, 114, 115, 116, 117, 118, and/or 119 of the transducers 210 are facing at least one of the elements 151, 152, 153, 154, 155, 156, 157, 158, and/or 159 of the transducers 310, the wave front of the beam 180 may arrive at the transducers 310 (e.g., such as beam 180b and/or 180c as shown in FIG. 9), although some part of the wave front may propagate out into space and miss the transducers 310, such as beam 180a shown in FIG. 9.

In some implementations of the disclosed subject matter shown in FIGS. 1-9, a transducer signal generator may be included with a computing device 330 of the receiving wireless power transfer device 150 to generate control signals for the generation of a coherent phase beam by the transducers 310. The coherent phase control signals may be sent to a transducer control 320, which may control the transducers 310 to generate a beam. The beam may have a coherent phase at its origin across the transducers 310. For example, the waveforms generated by the elements 151, 152, 153, 154, 155, 156, 157, 158, and/or 159 may all be in phase. The wave front of the beam may propagate away from the transducers 310. The receiving wireless power transfer device 150 may transmit the beam for any suitable length of time. For example, the receiving wireless power transfer device 150 may transmit the beam for a short duration (e.g., for a predetermined period of time), to conserve power, or until an out-of-band confirmation that the beam was detected is received from the transmitting wireless power transfer device 100. In some implementations, the beam may be transmitted by the transducers 310 using a defined phase pattern. For example, the elements 151, 152, and/or 153 may transmit in phase with each other, the elements 154, 155, and/or 156 may transmit in phase with each other and out-of-phase with the elements 151, 152, and/or 153 by 45 degrees, and the elements 157, 158, and/or 159 may transmit in phase with each other and out-of-phase with the elements 151, 152, and/or 153 by 90 degrees.

In the implementation described above, the transducers 210 may be operating in a receiving mode. For example, the receiving wireless power transfer device 150 may indicate through out-of-band communications with the transmitting wireless power transfer device 100 that it intends to transmit the beam, or the transducers 210 may enter a receiving mode at specified intervals. The transducers 210 may detect the beam. For example, the wave front of the beam may arrive at the elements 111, 112, 113, 114, 115, 116, 117, 118, and/or 119. The transducer control 220 may receive the electrical signals generated by the transducers 210 from the energy carried by the beam, and may determine properties of the wave front of the beam at the transducers 210. For example, the transducer control 220 may determine the phase and amplitude of the wave front as experienced at each transducer, or element, of the transducers 210. The determined properties of the wave front of the beam as experienced at the transducers 210 may be sent to the transducer signal generator 231. In some implementations, the transducer control 220 may pass the electrical signals as received from the transducers 210 to the transducer signal generator 231, which may analyze the electrical signals to determine the properties of the wave front of the beam as experienced at the transducers 210.

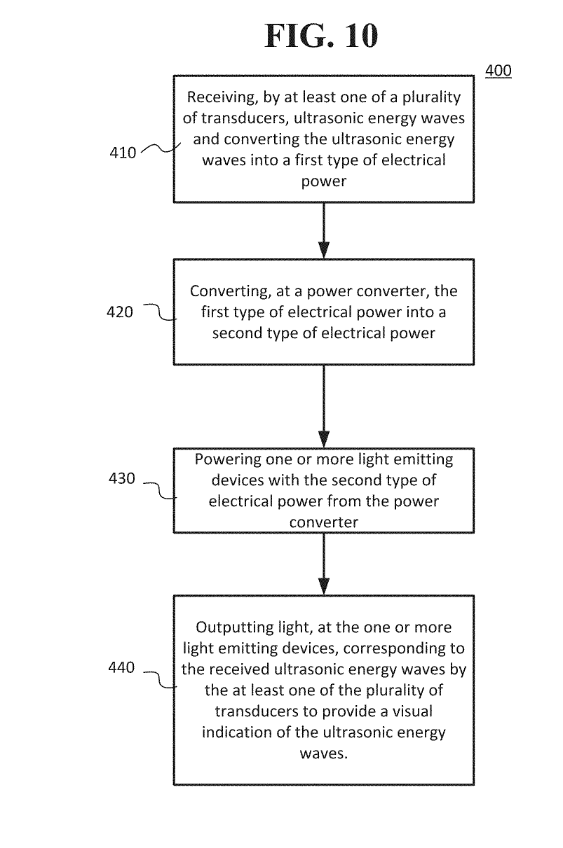

FIG. 10 shows an example method 400 of visualizing a wireless power transfer according to an implementation of the disclosed subject matter. At operation 410, at least one of a plurality of transducers, may receive ultrasonic energy waves and convert the ultrasonic energy waves into a first type of electrical power. As discussed above in connection with FIGS. 1 and 3, one or more of the elements 151, 152, 153, 154, 155, 156, 157, 158, and/or 159 of the transducers 310 may receive the ultrasonic energy waves (e.g., wave 180), and convert the ultrasonic energy waves to a first type of electrical power (e.g., AC electrical power). The ultrasonic energy waves may be first converted to mechanical energy by at least one of the plurality of transducers, and then the mechanical energy may be converted into electrical power by the transducers. At operation 420, a power converter (e.g., transducer control 320, computing device 330, and/or power converter 190) may convert the first type of electrical power (e.g., AC electrical power) into a second type of electrical power (e.g., DC electrical power). In operations 410 and 420 discussed above, as well as discussed above in connection with FIGS. 3-4, ultrasonic energy waves may be first converted to AC electrical power, and then converted to DC electrical power.

At operation 430, one or more light emitting devices (e.g., one or more of the elements 302, 304, 306, and/or 308 of light emitting device 300) may be powered with the second type of electrical power from the power converter (e.g., DC electrical power from transducer control 320, computing device 330, and/or power converter 190). At operation 440, the one or more light emitting devices may output light that corresponds to the received ultrasonic energy waves (e.g., wave 180) by the at least one of the plurality of transducers (e.g., elements 151, 152, 153, 154, 155, 156, 157, 158, and/or 159 of the transducers 310) to provide a visual indication of the ultrasonic energy waves. For example, the one or more light emitting devices output light corresponding to the received ultrasonic energy waves to provide a visual indication of the focus and directionality of the ultrasonic energy waves.

In some implementations of the disclose subject matter, the method 400 may include receiving the ultrasonic energy waves by at least a first transducer of the plurality of transducers, where at least a second transducer of the plurality of transducers does not receive the ultrasonic energy waves based on the focus and directionality of the ultrasonic energy waves. The first transducer and the second transducer of the plurality of transducers may be disposed adjacent to one another. In some implementations, the first transducer and the second transducer of the plurality of transducers may be disposed vertically, horizontally, or diagonally adjacent to one another.

In some implementations, an intensity of the light output by the one or more light emitting devices may be based on at least one of a directionality and an amplitude of the ultrasonic energy waves received by the at least one of the plurality of transducers. The at least one color of the light output by the one or more light emitting devices may be based on at least one of a directionality and an amplitude of the ultrasonic energy waves received by the at least one of the plurality of transducers. The one or more light emitting devices (e.g., one or more of the elements 302, 304, 306, and/or 308 of light emitting device 300) output light that may correspond to at least one of at least a portion of a dispersion pattern of the received ultrasonic energy waves, strength of the received ultrasonic energy waves, and coverage area of the received ultrasonic energy waves.

In some implementations, the method 400 may include determining a placement of at least one of a transmitter transducer (e.g., the elements 111, 112, 113, 114, 115, 116, 117, 118, and/or 119 of the transducers 210 of the wireless power transfer device 100) to output the ultrasonic energy waves (e.g., wave 180) in a location based on the light output by the light emitting device (e.g., light emitting device 300). The method may include determining the placement of the at least one transmitter transducer based on at least one of a distance between the at least one transmitter transducer and at least one of the plurality of transducers to receive ultrasonic energy waves, and an angular orientation of the at least one transmitter transducer to the at least one of the plurality of transducers to receive ultrasonic energy waves. Thus, the direction, intensity and/or phase of the ultrasonic energy detected and shown by implementations of the disclosed subject matter may be used to adjust the orientation of the transmitter, the relative orientation of the transmitter and receiver to each other and/or the distance between the transmitter and receiver to optimize one or more characteristics of the energy transfer system, such as the amount of power transferred from transmitter to receiver and/or the coherence of all or part of the wave front of transmitted energy at the receiver. The orientation of the transmitter and/or receiver can be adjusted in azimuth and elevation. In an implementation, the azimuth of a transmitter is changed in a given direction. If the detected power level increases as a result of the azimuth change, another incremental change in azimuth in the same direction is made. If the power level decreased, the change in azimuth is reversed. This process can be repeated so that azimuth is incrementally changed until detected power received decreases. Likewise, the same process can be performed for changes in elevation. In an implementation, changes in azimuth are interspersed with changes in elevation. In this way, detected changes in power level and/or phase can be used to guide changes in the orientation of the transmitter and/or receiver to optimize the received power level, phase, or a combination thereof. A configuration may be optimized when it maximizes one or more parameters, or when it produces a result that is closest to a given target, e.g., a given power level and a given phase, or averages thereof.

Embodiments of the presently disclosed subject matter discussed above in connection with FIGS. 1-10 may be implemented in and used with a variety of component and network architectures. FIG. 11 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 12.

Many other devices or components (not shown) may be connected in a similar manner, such as document scanners, digital cameras, auxiliary, supplemental, or backup systems, or the like. Conversely, all of the components shown in FIG. 11 need not be present to practice the present disclosure. The components can be interconnected in different ways from that shown. The operation of a computer such as that shown in FIG. 11 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 12 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system comprising:
at least one of a plurality of transducers to receive ultrasonic energy waves and convert the received ultrasonic energy waves into a first type of electrical power;
a power converter to convert the first type of electrical power into a second type of electrical power; and
one or more light emitting devices that are powered with the second type of electrical power from the power converter to output light corresponding to the received ultrasonic energy waves by the at least one of the plurality of transducers to provide a visual indication of the received ultrasonic energy waves.

2. The system of claim 1, wherein the first type of electrical power is alternating current (AC) and the second type of electrical power is direct current (DC).

3. The system of claim 1, wherein the one or more light emitting devices output light corresponding to the received ultrasonic energy waves to provide a visual indication of the focus and directionality of the ultrasonic energy waves.

4. The system of claim 3, wherein at least a first transducer of the plurality of transducers receives the ultrasonic energy waves, and at least a second transducer of the plurality of transducers does not receive the ultrasonic energy waves based on the focus and directionality of the ultrasonic energy waves.

5. The system of claim 4, wherein the first transducer and the second transducer of the plurality of transducers are disposed adjacent to one another.

6. The system of claim 5, wherein the first transducer and the second transducer of the plurality of transducers are disposed vertically, horizontally, or diagonally adjacent to one another.

7. The system of claim 1, wherein an intensity of the light output by the one or more light emitting devices is based on at least one from the group consisting of: a directionality and an amplitude of the ultrasonic energy waves received by the at least one of the plurality of transducers.

8. The system of claim 1, wherein at least one color of the light output by the one or more light emitting devices is based on at least one from the group consisting of: a directionality and an amplitude of the ultrasonic energy waves received by the at least one of the plurality of transducers.

9. The system of claim 1, wherein the one or more light emitting devices output light that corresponds to at least one from the group consisting of: at least a portion of a dispersion pattern of the received ultrasonic energy waves, strength of the received ultrasonic energy waves, and coverage area of the received ultrasonic energy waves.

10. The system of claim 1, wherein the light output by the light emitting device is used to determine a placement of at least one of a transmitter transducer to output the ultrasonic energy waves in a location.

11. The system of claim 10, wherein the light output by the light emitting device is used to determine the placement of the at least one transmitter transducer based on at least one from the group consisting of: a distance between the at least one transmitter transducer and at least one of the plurality of transducers to receive ultrasonic energy waves, and an angular orientation of the at least one transmitter transducer to the at least one of the plurality of transducers to receive ultrasonic energy waves.

12. A method comprising:
receiving, by at least one of a plurality of transducers, ultrasonic energy waves and converting the ultrasonic energy waves into a first type of electrical power;
converting, at a power converter, the first type of electrical power into a second type of electrical power; and
powering one or more light emitting devices with the second type of electrical power from the power converter; and
outputting light, at the one or more light emitting devices, corresponding to the received ultrasonic energy waves by the at least one of the plurality of transducers to provide a visual indication of the ultrasonic energy waves.

13. The method of claim 12, wherein the first type of electrical power is alternating current (AC) and the second type of electrical power is direct current (DC).

14. The method of claim 12, wherein the one or more light emitting devices output light corresponding to the received ultrasonic energy waves to provide a visual indication of the focus and directionality of the ultrasonic energy waves.

15. The method of claim 14, further comprising:
receiving, by at least a first transducer of the plurality of transducers, the ultrasonic energy waves,
wherein at least a second transducer of the plurality of transducers does not receive the ultrasonic energy waves based on the focus and directionality of the ultrasonic energy waves.

16. The method of claim 15, further comprising:
disposing the first transducer and the second transducer of the plurality of transducers adjacent to one another.

17. The method of claim 16, further comprising:
disposing the first transducer and the second transducer of the plurality of transducers vertically, horizontally, or diagonally adjacent to one another.

18. The method of claim 12, wherein an intensity of the light output by the one or more light emitting devices is based on at least one from the group consisting of: a directionality and an amplitude of the ultrasonic energy waves received by the at least one of the plurality of transducers.

19. The method of claim 12, wherein at least one color of the light output by the one or more light emitting devices is based on at least one from the group consisting of: a directionality and an amplitude of the ultrasonic energy waves received by the at least one of the plurality of transducers.

20. The method of claim 12, wherein the one or more light emitting devices output light that corresponds to at least one from the group consisting of: at least a portion of a dispersion pattern of the received ultrasonic energy waves, strength of the received ultrasonic energy waves, and coverage area of the received ultrasonic energy waves.

21. The method of claim 12, further comprising:
determining a placement of at least one of a transmitter transducer to output the ultrasonic energy waves in a location based on the light output by the light emitting device.

22. The method of claim 21, further comprising:
determining the placement of the at least one transmitter transducer based on at least one from the group consisting of: a distance between the at least one transmitter transducer and at least one of the plurality of transducers to receive ultrasonic energy waves, and an angular orientation of the at least one transmitter transducer to the at least one of the plurality of transducers to receive ultrasonic energy waves.
